(19) United States
(12) Patent Application Publication
(10) Pub. No.: US 2004/0162141 A1
(43) Pub. Date: Aug. 19, 2004

(54) Device for interacting with real-time streams of content

(76) Inventor: Marcelle Andrea Stienstra, Eindhoven (NL)

Correspondence Address: Philips Electronics North America Corporation, Corporate Patent Counsel, PO Box 3001, Briarcliff Manor, NY, 10510, US

(21) Appl. No.: 10/477,494

(22) PCT Filed: May 14, 2002
(86) PCT No.: PCT/IB02/01665

(30) Foreign Application Priority Data
May 14, 2001 (EP) 01201798.4

(51) Int. Cl. G06F 17/00

(52) U.S. Cl. 463/36

(57) ABSTRACT

An end-user system (10) for transforming real-time streams of content into an output presentation includes a user interface (30) that allows a user to interact with the streams. The user interface includes a moveable object (32) and a fixed object (36), which is divided into a plurality of sections (38). A user operates the user interface (30) by causing the moveable object (32) to move onto the fixed object (36), and each section (38) of the fixed object (36) that is struck by the moveable object (32) produces a magnetic field. The combination of magnetic fields produced on the fixed object (36) determines which streams of contact are activated or deactivated. The present invention allows a user to adapt the presentation according to his/her own preferences, instead of merely being a spectator.

The present invention relates to a system and method for receiving and displaying real-time streams of content. Specifically, the present invention enables a user to interact with and personalize the displayed real-time streams of content.

Storytelling and other forms of narration have always been a popular form of entertainment and education. Among the earliest forms of these are oral narration, song, written communication, theater, and printed publications. As a result of the technological advancements of the nineteenth and twentieth century, stories can now be broadcast to large numbers of people at different locations. Broadcast media, such as radio and television, allow storytellers to express their ideas to audiences by transmitting a stream of content, or data, simultaneously to end-user devices that transforms the streams for audio and/or visual output.

Such broadcast media are limited in that they transmit a single stream of content to the end-user devices, and therefore convey a story that cannot deviate from its predetermined sequence. The users of these devices are merely spectators and are unable to have an effect on the outcome of the story. The only interaction that a user can have with the real-time streams of content broadcast over television or radio is switching between streams of content, i.e., by changing the channel. It would be advantageous to provide users with more interaction with the storytelling process, allowing them to be creative and help determine how the plot unfolds according to their preferences, and therefore make the experience more enjoyable.

At the present time, computers provide a medium for users to interact with real-time streams of content. Computer games, for example, have been created that allow users to control the actions of a character situated in a virtual environment, such as a cave or a castle. A player must control his/her character to interact with other characters, negotiate obstacles, and choose a path to take within the virtual environment. In on-line computer games, streams of real-time content are broadcast from a server to multiple personal computers over a network, such that multiple players can interact with the same characters, obstacles, and environment. While such computer games give users some freedom to determine how the story unfolds (i.e., what happens to the character), the story tends to be very repetitive and lacking dramatic value, since the character is required to repeat the same actions (e.g. shooting a gun), resulting in the same effects, for the majority of the game's duration.

Various types of children's educational software have also been developed that allows children to interact with a storytelling environment on a computer. For example, LivingBooks® has developed a type of “interactive book” that divides a story into several scenes, and after playing a short animated clip for each scene, allows a child to manipulate various elements in the scene (e.g., “point-and-click” with a mouse) to play short animations or gags. Other types of software provide children with tools to express their own feelings and emotions by creating their own stories. In addition to having entertainment value, interactive storytelling has proven to be a powerful tool for developing the language, social, and cognitive skills of young children.

However, one problem associated with such software is that children are usually required to using either a keyboard or a mouse in order to interact. Such input devices must be held in a particular way and require a certain amount of hand-eye coordination, and therefore may be very difficult for younger children to use. Furthermore, a very important part of the early cognitive development of children is dealing with their physical environment. An interface that encourages children to interact by “playing” is advantageous over the conventional keyboard and mouse interface, because it is more beneficial from an educational perspective, it is more intuitive and easy to use, and playing provides a greater motivation for children to participate in the learning process. Also, an interface that expands the play area (i.e., area in which children can interact), as well as allowing children to interact with objects they normally play with, can encourage more playful interaction.

ActiMates™ Barney™ is an interactive learning product created by Microsoft Corp.®, which consists of a small computer embedded in an animated plush doll. A more detailed description of this product is provided in the paper, E. Strommen, “When the Interface is a Talking Dinosaur: Learning Across Media with ActiMates Barney,” Proceedings of CHI '98, pages 288-295. Children interact with the toy by squeezing the doll's hand to play games, squeezing the doll's toe to hear songs, and covering the doll's eyes to play “peek-a-boo.” ActiMates Barney can also receive radio signals from a personal computer and coach children while they play educational games offered by ActiMates software. While this particular product fosters interaction among children, the interaction involves nothing more than following instructions. The doll does not teach creativity or collaboration, which are very important in the developmental learning, because it does not allow the child to control any of the action.

CARESS (Creating Aesthetically Resonant Environments in Sound) is a project for designing tools that motivate children to develop creativity and communication skills by utilizing a computer interface that converts physical gestures into sound. The interface includes wearable sensors that detect muscular activity and are sensitive enough to detect intended movements. These sensors are particularly useful in allowing physically challenged children to express themselves and communicate with others, thereby motivating them to participate in the learning process. However, the CARESS project does not contemplate an interface that allows the user any type of interaction with streams of content.

It is an object of the invention to allow users to interact with real-time streams of content received at an end-user device. This object is achieved in a user interface for interacting with a device that receives and transforms streams of content into a presentation to be output, comprising: a moveable object; a fixed object having multiple sections, each section producing a magnetic field when contacted by said moveable object, wherein the presentation is controlled based on the influence of the moveable object on the magnetic fields produced by the multiple sections of the fixed object.

Real-time streams of content are transformed into a presentation that is output to the user by an output device, such as a television or computer display. The presentation conveys a narrative whose plot unfolds according to the transformed real-time streams of content, and the user's interactions with these streams of content help determine the outcome of the story by activating or deactivating streams of content, or by modifying the information transported in these streams.

The user interface allows users to interact with the real-time streams of content in a simple, direct, and intuitive manner. The user interface provides users with physical, as well as mental, stimulation while interacting with real-time streams of content.

One embodiment of the present invention is directed to a system comprising: an end-user device for receiving and transforming streams of content into a presentation; a user interface including a moveable object and a fixed object having a plurality of sections, each section producing a magnetic field when contacted by said moveable object, and an output device for outputting the presentation, wherein said streams of content are activated or deactivated in said presentation based on the magnetic fields produced by said sections.

The user interface includes a moveable object, which could be magnetic or metallic and has a particular magnetic field associated therewith, and a fixed object that is divided into several sections, each section capable of having a magnetic field associated with it. When the user rolls, throws, or somehow causes the moveable object to move onto the fixed object, a magnetic field is produced at each section of the fixed object that is contacted, or struck, by the moveable object. The magnetic field produced at each section corresponds to the magnetic field of the moveable object. The combination of magnetic fields produced on the fixed object determines which streams of content are activated or deactivated in the system.

Another embodiment of the present invention is directed to a method of a system for transforming streams of content into a presentation to be output, comprising: associating a stream of content with one or more sections of a fixed object, said fixed object having a plurality of sections; producing a magnetic field on every section of the fixed object that is contacted by a moveable object; activating or deactivating said stream of content in said presentation based on whether or not a magnetic field is produced at the section of the fixed object associated with said stream of content.

Various advantageous embodiments are set out in the dependent claims.

These and other embodiments of the present invention will become apparent from and elucidated with reference to the following detailed description considered in connection with the accompanying drawings.

It is to be understood that these drawings are designed for purposes of illustration only and not as a definition of the limits of the invention for which reference should be made to the appending claims.

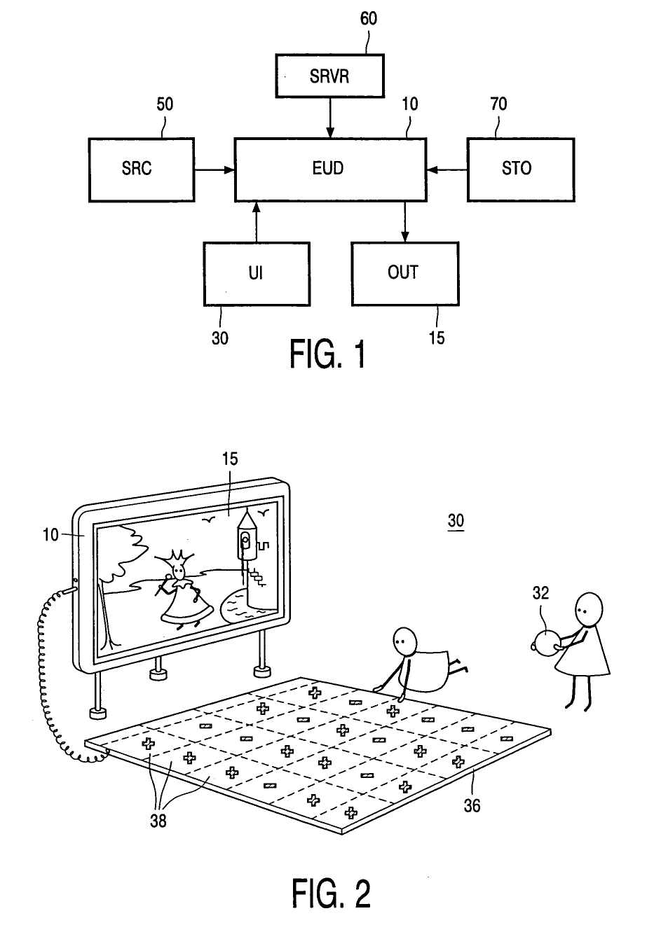

FIG. 1 is a block diagram illustrating the configuration of a system for transforming real-time streams of content into a presentation.

FIG. 2 illustrates the user interface of the present invention.

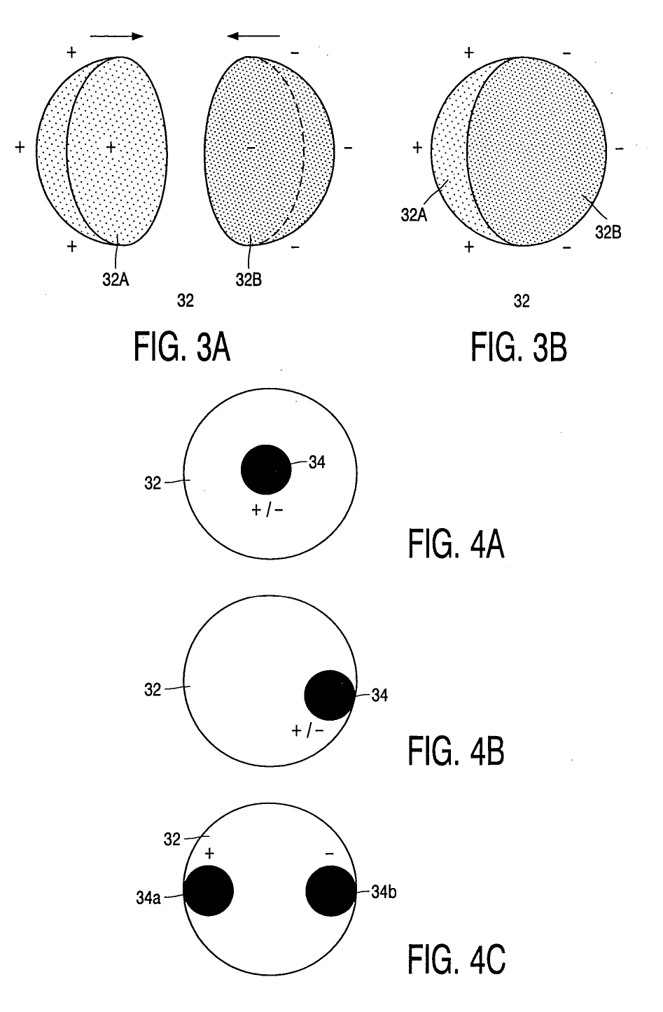

FIGS. 3A and 3B illustrates a moveable object, embodied as a metallic ball, having two different magnetic fields for use with the user interface.

FIGS. 4A, 4B, and 4C illustrate different configurations of the magnet disposed inside the magnetic ball of FIGS. 3A and 3B.

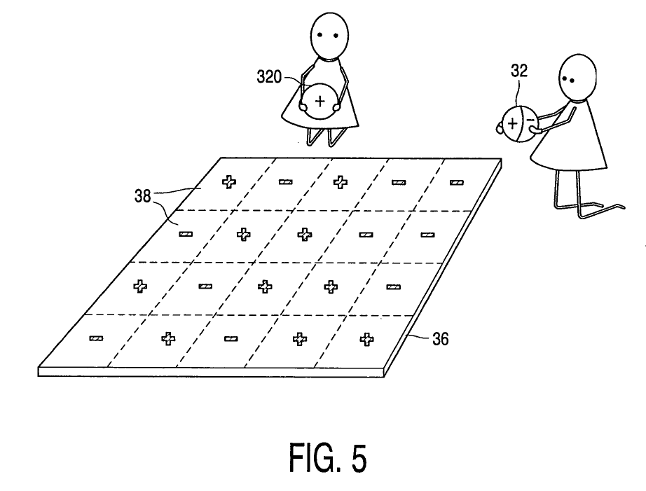

FIG. 5 illustrates an embodiment where a moveable object represents a stream of content to be activated or deactivated according to the user interface.

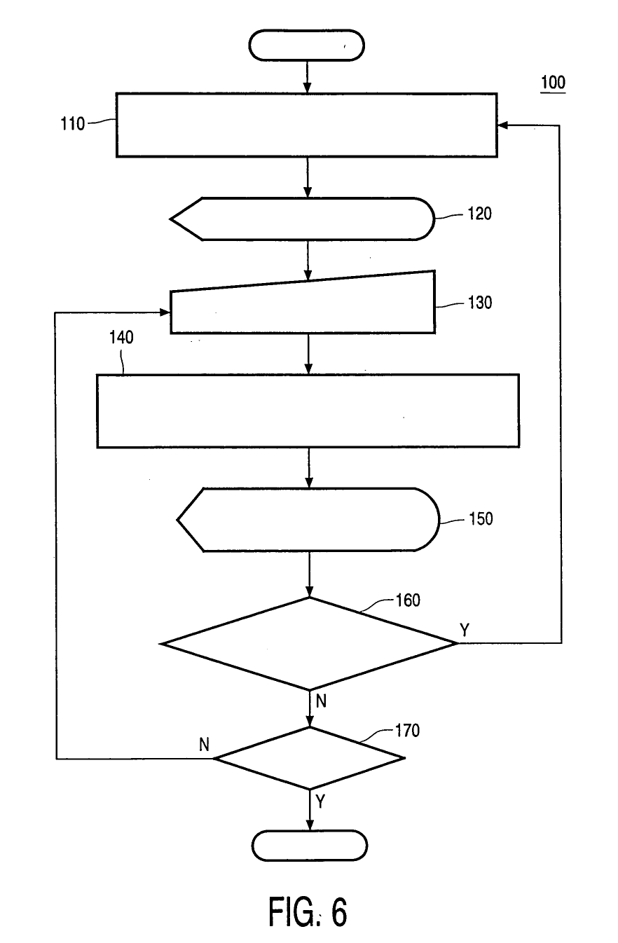

FIG. 6 is a flowchart illustrating the method whereby real-time streams of content can be transformed into a narrative.

Referring to the drawings, FIG. 1 shows a configuration of a system for transforming real-time streams of content into a presentation, according to an exemplary embodiment of the present invention. An end-user device 10 receives real-time streams of data, or content, and transforms the streams into a form that is suitable for output to a user on output device 15. The end-user device 10 can be configured as either hardware, software being executed on a microprocessor, or a combination of the two. One possible implementation of the end-user device 10 and output device 15 of the present invention is as a set-top box that decodes streams of data to be sent to a television set. The end-user device 10 can also be implemented in a personal computer system for decoding and processing data streams to be output on the CRT display and speakers of the computer. Many different configurations are possible, as is known to those of ordinary skill in the art.

The real-time streams of content can be data streams encoded according to a standard suitable for compressing and transmitting multimedia data, for example, one of the Moving Picture Experts Group (MPEG) series of standards, in particular MPEG-4. However, the real-time streams of content are not limited to any particular data format or encoding scheme. As shown in FIG. 1, the real-time streams of content can be transmitted to the end-user device over a wire or wireless network, from one of several different external sources, such as a television broadcast station 50 or a computer network server. Alternatively, the real-time streams of data can be retrieved from a data storage device 70, e.g. a CD-ROM, floppy-disc, or Digital Versatile Disc (DVD), which is connected to the end-user device.

As discussed above, the real-time streams of content are transformed into a presentation to be communicated to the user via output device 15. In an exemplary embodiment of the present invention, the presentation conveys a story, or narrative, to the user. Unlike prior art systems that merely convey a story whose plot is predetermined by the real-time streams of content, the present invention includes a user interface 30 that allows the user to interact with the story and help determine its outcome, by activating or deactivating streams of content associated with the story. For example, each stream of content may cause the story to follow a particular storyline, and the user determines how the plot unfolds by activating a particular stream, or storyline. Therefore, the present invention allows the user to exert creativity and personalize the story according to his/her own wishes.

However, the present invention is not limited to transforming real-time streams of content into a story to be presented to the user. According to other exemplary embodiments of the present invention, the real-time streams can be used to convey songs, poems, musical compositions, games, virtual environments, adaptable images, or any other type of content with which the user can adapt according to his/her personal wishes.

As mentioned above, FIG. 2 shows in detail the user interface 30 including a moveable object 32 and a fixed object 36, which is divided into sections 38. FIG. 2 shows an exemplary embodiment where the moveable object 32 is embodied as a magnetic ball and the fixed object 36 is embodied as a mat. The user interface 30 of the present invention is in no way limited to a magnetic ball and mat configuration. The fixed object 36 may take the form of any stationary object that can be divided into discernable sections. Further, the moveable object may comprise any type of metallic or magnetic object having a magnetic field, which can be thrown, rolled, or somehow caused to move onto one of the sections on the fixed object 36. However, in order to more easily describe the present invention, many of the exemplary embodiments will be described below with respect to the magnetic ball/mat configuration of the user interface.

The magnetic ball 32 has an associated magnetic field produced by a magnet 34 that is embedded within the ball. According to an exemplary embodiment, the magnetic ball 32 may have either a positive or negative magnetic field. Alternatively, FIGS. 3A and 3B illustrates another exemplary embodiment in which the magnetic ball 32 is comprised of two hemispheres 32A and 32B, where hemisphere 32A has a positive magnetic field and hemisphere 32B has a negative magnetic field.

FIG. 4A illustrates an exemplary embodiment of the present invention in which a magnetic field is produced in the magnetic ball 32 by a magnet 34 placed in the center of the magnetic ball. FIG. 4B illustrates an alternative exemplary embodiment in which the magnet 34 is eccentrically placed within the magnetic ball 32. FIG. 4C illustrates an exemplary embodiment where the magnetic ball has both a positive and negative magnetic field, which are produced by two different magnets 34a and 34b, respectively.

A user interacts with the end-user device 10 by rolling or throwing the magnetic ball 32 onto the mat 36. According to an exemplary embodiment of the invention, whenever the magnetic ball 32 makes contact with a mat section 38, a magnetic field is produced at that mat section 38 corresponding to the magnetic field of the magnetic ball 32. In other words, if a magnetic ball 32 having a positive magnetic field strikes a particular section 38, a positive magnetic field is produced at that particular mat section 38. A negative magnetic field would be produced at any mat section 38 that was struck with a magnetic ball 32 having a negative field. If a ball 32 having both a positive and negative magnetic field, as illustrated in FIGS. 3A and 3B, strikes a mat section 38, a magnetic field will be produced corresponding to whichever hemisphere of the ball strikes the mat section 38 (i.e., a positive magnetic field is produced at each section 38 being struck by the hemisphere having a positive magnetic field, and a negative magnetic field is produced at each section 38 being struck by the hemisphere having a negative magnetic field).

In an exemplary embodiment, information relating to the magnetic field produced at each mat section 38 as a result of the interactions of the user(s) may be stored in a storage device. This magnetic field information may be stored at the end-user device 10, at a storage device integrated into the mat 36, or at another location. Accordingly, the magnetic field associated with a mat section 38 may be detected by the end-user device 10 according to magnetic fields produced as a result of a user's interactions (with the ball 32 and mat 36) or according to the previously stored magnetic field information of the mat section 38.

However, not all of the magnetic fields are produced on the mat 36 as a result of the user's actions. In an exemplary embodiment, Magnetic fields may also be produced at certain mat sections 38 according to information transmitted along with the streams of content by the content providers. For instance, control data may be provided with the real-time streams of content received at the end-user device 10 that cause magnetic fields to be produced at certain mat sections 38. This allows the creator(s) of the real-time streams of content to have some control over what streams of content are activated and deactivated. The author(s) of a narrative can have a certain amount of control as to how the plot unfolds by activating or deactivating certain streams of content according to the control data within the transmitted real-time streams of content.

The end-user device 10 determines which streams of content should be activated or deactivated according to the magnetic fields produced on the mat 36. In an exemplary embodiment, each mat section 38 corresponds to a particular real-time stream of content. A positive field produced at a mat section may cause the corresponding stream of content to be activated, while a negative field causes a stream of content to be deactivated. In such an embodiment, the user may choose between throwing a magnetic ball 32 having a positive magnetic field or a magnetic ball 32 having a negative magnetic field on the mat, depending on whether the user wishes to activate or deactivate a particular stream of content. The user may also choose a ball having both a positive and negative magnetic field, to randomly activate or deactivate streams of content.

Additionally, the mat 36 may include markings that indicate what type of stream of content corresponds to each mat section 38. For example, if one particular mat section 38 corresponds to a stream of content that, when activated, causes a frog to appear in the presentation, a picture of a frog may be painted on that particular mat section 38. If another section 38 corresponds to the main character drawing his sword, a picture of a sword may be painted on the section 38.

According to another exemplary embodiment, a stream of content may be activated or deactivated according to a combination of positive and negative magnetic fields produced at different mat sections 38. In such an embodiment, the end-user device 10 maps the combination of magnetic fields produced on the mat 36 to the corresponding activation/deactivation of streams of content.

Another exemplary embodiment of the present invention includes a magnetic ball 320 that corresponds to a stream of content. In this embodiment, the magnetic ball 320 is thrown or rolled on the mat 36, and the stream of content represented by the ball 320 is activated or deactivated according to the magnetic field of the mat section 38 on which the magnetic ball 320 lands. An example of this embodiment is illustrated in FIG. 5, which shows two users interacting with the system. A first user produces magnetic fields on different sections of the mat by rolling or throwing magnetic ball 32 on the mat. Each mat section 38 that is struck by the magnetic ball 32 produces a magnetic field similar to that of the ball 32, as described above in connection with FIG. 2. Then, a second user throws or rolls the magnetic ball 320, which corresponds to a stream of content, onto the mat to determine if the stream of content is activated or deactivated. For example, if the magnetic ball 320 lands on a mat section 38 having a positive field, then the stream of content represented by the ball 320 is activated; else, if the ball 320 lands on a section 38 with a negative field, the stream of content is deactivated. It is further noted that, in this embodiment, the real-time streams of content received at the end-user device 10 can determine the magnetic fields produced at each mat section 38, instead of using the magnetic ball 32.

In a further exemplary embodiment, each section 38 of the mat 36 has a magnetic field, either positive or negative. In addition, the magnetic ball 32 has its own magnetic field. When the ball 32 is thrown or rolled onto the mat 36, it is attracted to those sections 38 having the opposite magnetic field polarity, and repulsed from sections 38 having the same magnetic field polarity. This attraction and repulsion helps determine the trajectory of the magnetic ball 32. In this embodiment, one or more streams can be activated or deactivated based on the trajectory followed by the ball 32.

As described above, an exemplary embodiment of the present invention is directed to an end-user device that transforms real-time streams of content into a narrative that is presented to the user through output device 15. One possible implementation of this embodiment is an interactive television system. The end-user device 10 can be implemented as a set-top box, and the output device 15 is the television set. The process by which a user interacts with such a system is described below in connection with the flowchart 100 of FIG. 6.

In step 110, the end-user device 10 receives a stream of data corresponding to a new scene of a narrative and immediately processes the stream of data to extract scene data. Each narrative presentation includes a series of scenes. Each scene comprises a setting in which some type of action takes place. Further, each scene has multiple streams of content associated therewith, where each stream of content introduces or changes an element that affects the plot.

For example, activation of a stream of content may cause a character to perform a certain action (e.g., a prince starts walling in a certain direction), cause an event to occur that affects the setting (e.g., thunderstorm, earthquake), or introduce a new character to the story (e.g., a frog). Conversely, deactivation of a stream of content may cause a character to stop performing a certain action (e.g., the prince stops walking), terminate an event (e.g., the thunderstorm or earthquake ends), or cause a character to depart from the story (e.g. the frog hops away).

The activation or deactivation of a stream of content may also change an internal property or characteristic of an object in the presentation. For example, activation of a particular stream may cause the mood of a character, such as the prince, to change from happy to sad. Such a change may become evident immediately in the presentation (e.g., the prince's smile becomes a frown), or may not be apparent until later in the presentation. Such internal changes are not limited to characters, and may apply to any object that is part of the presentation, which contains some characteristic or parameter that can be changed.

In step 120, the set-top box decodes the extracted scene data. The setting as extracted is displayed on a television screen, along with some indication to the user that he/she must determine how the story proceeds by using the user interface 30. As a result, the user rolls the ball on the mat 36, as shown in step 130, thereby producing positive and/or negative magnetic fields at different mat sections 38.

In step 140, the set-top box determines whether a positive or negative magnetic field has been produced on each mat section 38, and maps the resulting combination of magnetic fields into one or more streams of content to be activated and/or deactivated. As described above, each mat section 38 may correspond to a different stream of content. Therefore, depending on the sections 38 contacted by the magnetic ball 32, a plurality of different actions or events may occur in the narrative. In step 150, the new storyline is played out on the television according to the activated/deactivated streams of content. In this particular example, each stream of content is an MPEG-4 file, which is played on the television while activated.

In step 160, the set-top box determines whether the activated streams of content necessarily cause the storyline to progress to a new scene. If so, the process returns to step 110 to receive the streams of content corresponding to the new scene. However, if a new scene is not necessitated by the storyline, the set-top box determines whether the narrative has reached a suitable ending point in step 170. If this is not the case, the user is instructed to use the user interface 30 in order to activate or deactivate streams of content and thereby continue the story. The flowchart of FIG. 6 and the corresponding description above is meant to describe an exemplary embodiment, and is in no way limiting.

The present invention provides a system that has many uses in the developmental education of children. The present invention promotes creativity and development of communication skills by allowing children to express themselves by interacting with and adapting a presentation, such as a story. Children will find the user interface 30 of the present invention intuitive and easy to use, since it only requires an action that most children are very familiar with, e.g., rolling or throwing a ball. Further, the playful nature of the user interface 30 provides children with motivation to interact with the system. In addition, the playful nature of the interface 30 can induce children into learning about how certain objects react to other objects.

It should be noted, however, that the input device 30 of the present invention is in no way limited in its use to children, nor is it limited to educational applications. The present invention provides an intuitive and stimulating interface to interact with many different kinds of presentations geared to users of all ages.

A user can have a variety of different types of interactions with the presentation by utilizing the present invention. As mentioned above, the user may affect the outcome of a story by causing characters to perform certain types actions or by initiating certain events that affect the setting and all of the characters therein, such as a natural disaster or a weather storm. The user interface 30 can also be used to merely change details within the setting, such as changing the color of a building or the number of trees in a forest. However, the user is not limited to interacting with presentations that are narrative by nature. The user interface 30 can be used to choose elements shown in a picture, to determine the lyrics to be used in a song or poem, to take one's turn in a game, to interact with a computer simulation, or to perform any type of interaction that permits self-expression within a presentation.

The user's interactions may have a very logical connection to the manipulations required by the user interface 30. For example, the user may cause a character to move in a certain direction by rolling the ball in the same direction on the mat 36. Further, the user may utilize present invention to play a computer-simulated game or sport that requires an action similar to the action used to manipulate the user interface 30. Examples include rolling a magnetic ball 32 on the mat to simulate the rolling of a bowing ball down an alley, or flicking a ball on a mat to simulate the shooting of a marble. Similarly, the user interface 30 may be modified so that other items may be used in conjunction with the metallic ball 32 and the mat 36. A cue stick may be used to hit the metallic ball 32 on the mat 36 to simulate a game of pool; else, a golf club may be used to hit the metallic ball 32 on the mat 36 to simulate putting in golf.

As described above, the user interface 30 of the present invention is not limited to an embodiment comprising a magnetic ball 32 and mat 36. The present invention covers any type of user interface in which the spatial relationship of a moveable object (having a magnetic field or otherwise or otherwise) and to a fixed object, or to its own environment, determines the activation or deactivation of streams of content.

For example, the user interface 30 may include a moveable object 32 in the form of a die that is rolled on a fixed object 36 in the form of a game board, and the position of the die on the game board determines which streams are activated or deactivated. Such interaction would be familiar to children who frequently play board games. The user interface 30 may also be embodied as a toy car that is rolled on a mat or rug simulating a street, where streams of content are activated based on the car's position on the street. In the alternative embodiments described above, the game board and mat may each comprise a grid of sensors, such as piezoelectric cables, that sense the location of an object.

Alternatively, the user interface 30 may comprise a singular object, which contains sensors to determine the position of the object within the user's environment. The user may throw or roll the moveable object 32 (e.g., a ball, a toy car or airplane, etc.), and sensors within the object determine how far and in what direction the object has traveled. The sensor output may be transmitted by wire or radio signals to the end-user device 10, which activates or deactivates streams of content as a result. However, the user is not limited to rolling, throwing, or manually moving the moveable object 32. For example, the moveable object 32 may be a remote-controlled toy (e.g., car, robot, etc.), whose movement is controlled by the user.

The present invention has been described with reference to the exemplary embodiments. As will be evident to those skilled in the art, various modifications of this invention can be made or followed in light of the foregoing disclosure without departing from the spirit and scope of the claims. The reference numerals in the claims are illustrative only and do not limit the scope of the claims.

1. A user interface (30) for interacting with a device (10) that receives and transforms streams of content into a presentation to be output, comprising:
a moveable object (32);
a fixed object (36) having multiple sections (38), each section (38) producing a magnetic field when contacted by said moveable object (32),
wherein the presentation is controlled based on the influence of the moveable object (32) on the magnetic fields produced by the multiple sections (38) of the fixed object (36).

2. The user interface (30) according to claim 1, wherein said moveable object (32) has a magnetic field of either a positive or negative polarity, and
wherein a polarity of the magnetic field produced by a section (38) contacted by said moveable object (32) is the same as the magnetic field of said moveable object (32).

3. The user interface (30) according to claim 1, wherein said moveable object (32) includes first and second portions, said first portion having a magnetic field of positive polarity and said second portion having a magnetic field of negative polarity,
wherein a polarity of the magnetic field produced by a section (38) is positive when the first portion of said moveable object (32) contacts the section (38), and
wherein a polarity of the magnetic field produced by the section (38) is negative when the second portion of said moveable object (32) contacts the section (38).

4. The user interface (30) according to claim 1, wherein each section (38) corresponds to a received stream of content, and
wherein said stream of content is activated or deactivated in the presentation based on whether or not a magnetic field is produced by the corresponding section (38).

5. The user interface (30) according to claim 1, wherein each section (38) corresponds to a received stream of content,
wherein said stream of content is activated in the presentation if the corresponding section (38) produces a magnetic field having positive polarity, and
wherein said stream of content is deactivated in the presentation if the corresponding section (38) produces a magnetic field having negative polarity.

6. The user interface (30) according to claim 1, wherein said presentation includes a narrative.

7. A method in a system for transforming streams of content into a presentation to be output, comprising:
associating a stream of content with one or more sections (38) of a fixed object (36), said fixed object (36) having a plurality of sections (38);
producing a magnetic field on every section (38) of the fixed object (36) that is contacted by a moveable object (32);
activating or deactivating said stream of content in said presentation based on whether or not a magnetic field is produced at the section (38) of the fixed object (36) associated with said stream of content.

8. The method of claim 7, wherein said moveable object (32) has a magnetic field of either a positive or negative polarity, and
wherein a polarity of the magnetic field produced by a section (38) contacted by said moveable object (32) is the same as the magnetic field of said moveable object (32).

9. The method of claim 7, wherein each section (38) corresponds to a received stream of content, and
wherein said stream of content is activated or deactivated in the presentation based on whether or not a magnetic field is produced by the corresponding section (38).

10. A system comprising:
an end-user device (10) for receiving and transforming streams of content into a presentation;
a user interface (30) including a moveable object (32) and a fixed object (36) having a plurality of sections (38), each section (38) producing a magnetic field when contacted by said moveable object (32), and
an output device (15) for outputting the presentation,
wherein said streams of content are activated or deactivated in said presentation based on the magnetic fields produced by said sections (38).
